(19) United States
(12) Patent Application Publication
(10) Pub. No.: US 2026/0330311 A1
(43) Pub. Date: Oct. 22, 2026

(54) METHOD AND SYSTEM FOR GENERATING JAILBREAKING ATTACK TEST CASE FOR LARGE LANGUAGE MODEL

(71) Applicant: HANGZHOU DIANZI UNIVERSITY, Zhejiang (CN)

(72) Inventors: Chang SU, Zhejiang (CN); Zhendong WU, Zhejiang (CN); Jiangwei YE, Zhejiang (CN); Yunhao XUE, Zhejiang (CN); Fanyi XU, Zhejiang (CN); Zixuan GUO, Zhejiang (CN)

(73) Assignee: HANGZHOU DIANZI UNIVERSITY, Zhejiang (CN)

(21) Appl. No.: 19/537,415

(22) Filed: Feb. 11, 2026

(30) Foreign Application Priority Data
Apr. 17, 2025 (CN) 202510481810.1

(51) Int. Cl. G06N 20/00

(52) U.S. Cl. CPC G06N 20/00

(57) ABSTRACT

Disclosed are a method and system for generating a jailbreaking attack test case for a large language model. A plurality of pre-trained large language models (LLMs) are firstly selected as base models of submodels, a training data set of an unaligned submodel, a training data set of a jailbreaking judger submodel, and a training data set of a task decomposition submodel are constructed, and the unaligned submodel, the jailbreaking judger submodel, and the task decomposition submodel are trained separately. Secondly, according to the trained unaligned submodel, an intent hiding submodel is constructed. Then, based on the intent hiding submodel, a jailbreaking task judger quadruple is obtained, a reward function is constructed, and reinforcement learning is performed on the task decomposition submodel. Finally, the reward function is used to iteratively train the task decomposition submodel, and submodel components are assembled to complete automatic jailbreaking attack test case generation.

### CROSS-REFERENCE TO RELATED APPLICATION

This application claims the priority benefit of Chinese patent application No. 202510481810.1, filed on Apr. 17, 2025. The entirety of the above-mentioned patent application is hereby incorporated by reference herein and made a part of this specification.

### BACKGROUND

### Technical Field

The present disclosure relates to the field of large language model safety, and particularly relates to a method and system for generating a jailbreaking attack test case for a large language model.

### Description of Related Art

With rapid development of the large language models (LLMs) technology, its wide application in content generation, knowledge services and other fields has brought innovative changes to society, and also caused new safety risks. Jailbreaking attacks, as the core threat to break through a model safety protection mechanism, have become the key topic of artificial intelligence safety research. Such attacks guide a model to generate dangerous outputs such as false information, unethical contents and even network attack codes through well-designed antagonistic prompts or systematic vulnerability mining. This seriously influences digital ecological safety and artificial intelligence safety governance. At present, mainstream defense mechanisms for a large language model include keyword filtering, safety alignment, and hierarchical review of output contents. Main jailbreaking attack methods include a jailbreaking method with prompt-based attacks (such as an induced language and false scene setting), antagonistic attacks (by constructing antagonistic samples, such as specific character combinations or semantic disturbances), multilingual prompt attacks, a plurality of rounds of jailbreaking attacks based on context, etc. A method for identifying and exploring these jailbreaking attacks is an important technology to evaluate LLM safety and develop an LLM defense method.

Existing methods for generating a jailbreaking attack test case for a large language model mainly include manual synthesis by artificial experts, large language model-assisted generation, etc. However, with gradual improvement in a safety ability of a large language model, the existing large language model-assisted method for generating a jailbreaking attack test case generates gradually less effective safety test cases. In order to further investigate safety abilities of various existing large language models and assist the Red Team in testing a safety boundary of a large language model more effectively, it is necessary to explore a more effective method for obtaining an LLM jailbreaking attack case.

### SUMMARY

To overcome defects of the existing methods, the present disclosure provides a method and system for generating a jailbreaking attack test case for a large language model (LLM) through automatic task decomposition and intent hiding. The method is based on the following observations and tests: The present disclosure finds that an existing high-quality LLM has the following abilities: 1) an ability to accurately understand natural language semantics and relevant knowledge and concepts; 2) a natural language generation ability; 3) an inference ability based on semantics, knowledge, and concepts; and 4) some cognitive fuzzy zones existing in the LLM, which are similar to cognitive blind spots of human beings. This is determined by the fact that the LLM learns a human language and its internal logic, such that the LLM fails to accurately cover all safety boundaries. Based on the above abilities and characteristics of the large language model, the present disclosure considers that most of original sensitive tasks may be decomposed into a plurality of logically coherent and harmless subtasks, and the large language model may learn to decompose such type of tasks through training and other learning. Thus, the present disclosure proposes that one task decomposition large language model is trained to automatically decompose a sensitive task into a plurality of harmless subtasks, such that an explicit logical association between an entire original task and subtasks may be cut off, and intent hiding may be performed on the subtasks. Then, steps after decomposition and intent hiding are independently input into one large language model with safety protection and a strong ability, and an output of each subtask is obtained through a powerful language logic and a knowledge reserve ability. Finally, the outputs of all the subtasks are integrated to obtain a jailbreaking output case.

Principles of task decomposition and intent hiding methods are further explained as follows. In natural language, a complex task is decomposed into multi-level independent clauses, which involves dispersing core semantics of a main task into different subtasks. For example, explosive production is divided into three independent knowledge modules of chemistry, physics and engineering, and the modules are assigned to different subtasks. A process of intent hiding involves hiding an original intent into other forms of expression, such as using a low-resource language for expression (using a low-resource language to express the original intent), and using codes for expression (transforming original question and answer intents into a code completion task). Some low-resource languages may have cross-language representation isolation. That is, a plurality of languages are embedded into a space, and semantic vectors of low-resource languages are decoupled from high-resource languages. Code expression uses computer code languages to express implementation steps of a task, and has characteristics of concealment and multi-layer abstraction in grammatical structure.

In order to solve problems of insufficient and inefficient generation of test cases for a large language model, a first aspect of the present disclosure provides an automatic method for generating a jailbreaking attack test case for a large language model based on task decomposition and intent hiding. The method includes the following steps:
Step 1, base models are prepared.
Step 2, a training data set of an unaligned submodel is prepared.
Step 3, a training data set of a jailbreaking judger submodel is prepared.
Step 4, a training data set of a task decomposition submodel is prepared.
Step 5, the unaligned submodel LLM-UNALIGNED is trained.
Step 6, the jailbreaking judger submodel LLM-JUDGER is trained.
Step 7, the task decomposition submodel LLM-DECOMP is preliminarily trained.
Step 8, an intent hiding submodel LLM-INTENT-HIDING is constructed.
Step 9, a jailbreaking task judger quadruple is obtained.
Step 10, a reward function is constructed, and reinforcement learning is performed on the task decomposition submodel.
Step 11, the task decomposition submodel is trained.
Step 12, submodel components are assembled to complete automatic jailbreaking attack test case generation.

Further, a specific process of the present disclosure is as follows:
Step 1, base models LLM-BASE are prepared as follows: in order to facilitate training of submodels, one or more pre-trained LLMs have to be firstly selected as the base models of the submodels. The large-scale pre-trained LLMs are subjected to pre-training on a large-scale data set, supervised fine-tuning (SFT), reinforcement learning from human feedback (RLHF), and other steps. The LLMs have certain knowledge, dialogue abilities, inference abilities, and instruction following abilities. A user can control the LLMs to strictly follow instructions provided by the user to perform tasks or generate effective contents. In general cases, a “size” (a parameter magnitude order, and for example, a parameter magnitude of 32 B or 13 B) of the base model may be 1 magnitude order to 2 magnitude orders less than a “size” (for example, a parameter magnitude of 200 B or 600 B) of a target model LLM_TARGET preparing to obtain a jailbreaking output.
Step 2, the training data set of the unaligned submodel LLM-UNALIGNED is prepared as follows: a corresponding training data set has to be prepared to train the unaligned submodel LLM-UNALIGNED, and the data set consists of a “sensitive question-sensitive answer” combination pair. A sensitive question-sensitive answer combination set includes some question-answer pairs involving sensitive topics, such as violence, ethics and morality, crime, and punishment. Contents have to maintain diversity of data and certain coverage, and for example, include all types of main topics needed for safety alignment of a large language model, and include different questioning tones. Generally, 6000 or more data pairs are prepared.
Step 3, the training data set of the jailbreaking judger submodel LLM-JUDGER is prepared as follows: a function of the jailbreaking judger submodel LLM-JUDGER is to assign a score to a jailbreaking effect of the subtasks. The training data set consists of a set of a quadruple: an original task-decomposed subtasks-subtasks after task hiding-answers to the subtasks after task hiding for example (one quadruple corresponds to one task). The data set has to include positive examples and negative examples simultaneously. Labels of examples for facilitating successful jailbreaking correspond to high scores. In examples of failed jailbreaking, subtasks include obvious sensitive information, and their labels correspond to low scores.
Step 4, the training data set of the task decomposition submodel LLM-DECOMP is prepared as follows: a sensitive data set including a sensitive (dangerous) prompt is prepared for the task decomposition submodel LLM-DECOMP, where the sensitive data set only includes a sensitive task question and does not include a sensitive task answer. Types of sensitive prompt words included in the training data set should have certain coverage. Combining different types of sensitive (dangerous) prompt words can improve generalization of the task decomposition submodel LLM-DECOMP, reduce a probability of over-fitting the model to a problem in a field, and improve a jailbreaking success rate for tasks in different fields.
Step 5, the unaligned submodel LLM-UNALIGNED is trained as follows: based on the base model LLM-BASE prepared in the step 1, the unaligned submodel LLM-UNALIGNED is trained. The submodel LLM-UNALIGNED is used to perform automatic task decomposition, intent hiding, and subtask answer integration. Because of user preference alignment, ethical alignment and safety alignment, the base model LLM-BASE may be stopped when required to decompose a sensitive task, so the base model cannot be directly used for task decomposition. It is necessary to train the unaligned LLM, that is, the unaligned submodel LLM-UNALIGNED. A training method uses supervised fine-tuning. The training data set is a sensitive question-sensitive answer data set prepared in the step 2. Supervised fine-tuning can significantly improve performance of the model on a target task (answering a sensitive question) by learning labeled data of the task. Supervised fine-tuning can remove a safety barrier brought by the model in an RLHF stage. Supervised fine-tuning has to select full parameter fine-tuning instead of incremental fine-tuning. A full parameter fine-tuning training process covers a wide range of original safety alignment parameters, and incremental fine-tuning may only change performance of the model in some specific fields, and can hardly remove safety alignment completely.
Step 6, the jailbreaking judger submodel is trained as follows: the data set prepared in the step 3 is used, and the jailbreaking judger submodel LLM-JUDGER is trained based on the unaligned submodel LLM-UNALIGNED. The step is also implemented through supervised fine-tuning and full parameter fine-tuning.
Step 7, the task decomposition submodel LLM-DECOMP is preliminarily trained as follows: the training data set prepared in the step 4 is used and includes the sensitive data set including the sensitive (dangerous) prompt, the task decomposition submodel LLM-DECOMP is required to preliminarily decompose a task by combining prompt engineering, and outputs of the decomposed subtasks are obtained. A prompt engineering technology is used to prompt the submodel LLM-UNALIGNED (the base model of the task decomposition submodel LLM-DECOMP) to decompose a sensitive task (recorded as K10) into a plurality of subtasks (recorded as K11). In a prompt, steps of submodel generation are required to be robust enough, and the prompt needs to be logically coherent and include no sensitive information. Based on this, the steps are simplified. Meanwhile, the model is required to ensure that an intent of each subtask is harmless. In a training process, a few-shot prompting technology (the few-shot prompting technology is a kind of general technology in large language model prompt engineering) may be used, which is conducive to generation of an answer with higher quality.
Step 8, the intent hiding submodel (LLM-INTENT-HIDING) is constructed as follows: the unaligned submodel LLM-UNALIGNED is used as the base model, intent hiding methods usable by the model are provided and generally have 10 types to 20 types, such as using a low-resource language, using mixed language interference, and using codes for expression, few-shot prompting is provided, and the submodel LLM-INTENT-HIDING for performing intent hiding on subtasks based on context and prompt engineering is formed.
Step 9, the jailbreaking task judger quadruple is obtained as follows: each subtask K11 after task decomposition is input into the intent hiding submodel LLM-INTENT-HIDING to obtain an output, that is, a subtask (recorded as K12) after intent hiding, then each subtask K12 after intent hiding is input into a target model LLM_TARGET, and an output (recorded as K13) of each subtask is obtained. An original task (K10), the subtask (K11) after decomposition, the subtask (K12) after intent hiding and the output (K13) of the target model LLM_TARGET constitute a quadruple for judging whether a jailbreaking task is successful.
Step 10, the reward function is constructed, and reinforcement learning is performed on the task decomposition submodel as follows: the jailbreaking task judger quadruple obtained in the step 9 is input into the jailbreaking judger submodel LLM-JUDGER, and the judger submodel LLM-JUDGER gives a score of a decomposed task. A specific score is calculated by the reward function. The reward function is a general concept in the field of reinforcement learning. It is necessary to design the reward function to implement reinforcement learning. The reward function designed by the present disclosure is the sum of a reward value and a corresponding weight: rewards are classified into the following 3 types:
a concealment score r1 indicating whether the decomposed subtasks evade a safety filtering rule, that is, include no dangerous information;
an effectiveness score r2 indicating whether an answer of the target LLM (LLM_TARGET) to a subtask satisfies a requirement of the subtask; and
a rationality score r3 indicating whether the answer of the target LLM (LLM_TARGET) to the subtask is semantically coherent and logically rational.

Generally, if an answer in the quadruple is successful jailbreaking and the answer is semantically coherent and logically rational, the judger submodel LLM-JUDGER outputs a high-score evaluation. If an answer in the quadruple is not successful jailbreaking, the judger submodel LLM-JUDGER outputs a low-score evaluation.
Step 11, the task decomposition submodel LLM-DECOMP is trained as follows: the task decomposition submodel LLM-DECOMP is iteratively trained through the reward function designed in the step 10, and the task decomposition submodel LLM-DECOMP is obtained after a predetermined quantity of iterations or loss is reached. In the step, only reinforcement learning is performed to update parameters of the task decomposition submodel LLM-DECOMP and not update parameters of the intent hiding submodel LLM-INTENT-HIDING. It is generally considered that as long as the original task is decomposed accurately enough in a task decomposition stage and the subtasks do not trigger a safety boundary, it is not necessary to re-perform iteration on the intent hiding submodel LLM-INTENT-HIDING, and only use a context learning ability of the intent hiding submodel LLM-INTENT-HIDING to output a plurality of intent hiding solutions (such as a low-resource language and code expression mentioned above).
Step 12, the submodel components are assembled to complete automatic jailbreaking attack test case generation as follows: after iterative training of the step 11 is completed, decomposition and intent hiding are performed on the original task through the task decomposition submodel LLM-DECOMP and the intent hiding submodel LLM-INTENT-HIDING, the original task is input into the task decomposition submodel LLM-DECOMP to obtain all decomposed subtasks of the task, then all the decomposed subtasks are decomposed and input into the intent hiding submodel LLM-INTENT-HIDING, and subtasks after intent hiding are obtained. The subtasks after intent hiding are input into the target model LLM_TARGET separately, and answers are obtained. The unaligned submodel LLM-UNALIGNED is used to integrate all the answers, and a summary ability of the LLMs is used to obtain a final jailbreaking case answer. At present, the LLM has an ability to summarize and output a long text, that is, to identify key information in the text and ignore a redundant content, to combine different languages and expressions, and to perform outputting uniformly.

Based an identical inventive concept, a second aspect of the present disclosure provides an automatic system for generating a jailbreaking attack test case. The system includes:
a basic model supporting module used to perform training of a sensitive data set based on a base model, and obtain an unaligned submodel;
a task decomposition module obtained by reinforcement learning based on the unaligned submodel and used to decompose an original task into a plurality of subtasks;
an intent hiding module used to use the unaligned submodel, use a prompt engineering technology to perform intent hiding on the subtasks, and obtain an intent hiding submodel LLM-INTENT-HIDING;
a jailbreaking judger module trained through a training data set of a jailbreaking judger submodel based on the unaligned submodel LLM-UNALIGNED, and used to provide a reward signal for reinforcement learning during training of a task decomposition submodel LLM-DECOMP; and
a target model invoking module used to invoke a target model by invoking an open application programming interface (API) of the target model remotely.

By combining the above technical solution and the technical problems to be solved, the technical solution to be protected by the present disclosure has advantages and positive effects as follows:

The automatic system for generating a jailbreaking attack test case implements a closed-loop automation system from task decomposition, intent hiding, target LLM response to reinforcement learning feedback. Generally, it is difficult to cover all attack paths by manually designing jailbreaking prompt words and manually decomposing tasks, and a manual design process depends on people's knowledge of safety boundaries such as specific fields, laws and regulations. Thus, it is difficult to design a large number of prompt words in different fields, decompose tasks, and hide intents. Compared with manual jailbreaking prompt word design and manual task decomposition, the automatic system for generating a jailbreaking attack test case according to the present disclosure greatly improves jailbreaking efficiency, and meanwhile, can pay attention to rare language space and decompose and search for a plurality of attack paths through the task decomposition submodel repeatedly. The Red Team can be assisted in testing performance of the large language model in different aspects by searching for a variety of different attack paths, and LLM safety can be evaluated more comprehensively.

A dynamic resistance ability of the model is upgraded: A conventional static testing method lacks a dynamic upgrade ability, and relies heavily on manual testing by human experts, so the method can hardly adapt to a safety policy change of the target model LLM_TARGET. According to the present disclosure, the task decomposition submodel can automatically adapt to a safety policy update of the target model through a real-time reward signal (from feedback of a judger submodel) of online reinforcement learning. When a safety module of the target model is updated, the system can rebuild an effective jailbreaking path through a plurality of iterations, such that the Red Team can test different safety effects of the large language model.

Concealment augmentation is implemented: By disassembling a single sensitive request into multi-step insensitive sub-requests, a conventional keyword detection mechanism is evaded and a real intent of the original task is hidden. Multi-dimensional scores with semantic coherence and logical rationality are introduced into the judger submodel to ensure that the decomposition step is hidden and can guide the target model LLM_TARGET to output a content of the jailbreaking attack test case.

### BRIEF DESCRIPTION OF THE DRAWINGS

FIG. 1 is a flowchart of an automatic method for generating a jailbreaking attack test case for a large language model based on task decomposition and intent hiding according to an embodiment of the present disclosure.

FIG. 2 is a schematic diagram of an automatic system for generating a jailbreaking attack test case for a large language model based on task decomposition and intent hiding according to an embodiment of the present disclosure.

FIG. 3 is a data flowchart during training in automatic generation of a jailbreaking attack test case for a large language model based on task decomposition and intent hiding according to an embodiment of the present disclosure.

### DETAILED DESCRIPTIONS OF THE EMBODIMENTS

For making objectives, technical solutions and advantages of the present disclosure clearer, 3 concepts and drawings will be emphasized below, and then the present disclosure will be further described in detail in combination with embodiments and drawings.

### 1. Unaligned Submodel: LLM-UNALIGNED

The unaligned submodel LLM-UNALIGNED is used as a base model of a task decomposition submodel LLM-DECOMP and an intent hiding submodel LLM-INTENT-HIDING. Effectiveness of the unaligned submodel on bypassing safety alignment determines effectiveness of the task decomposition submodel and the intent hiding model to some extent. Meanwhile, the unaligned submodel is used as an integrated model of all answers, which requires an original base model LLM-BASE to have a sufficient summary ability. Supervised fine-tuning may be used to train the unaligned submodel LLM-UNALIGNED. The data set consists of a sensitive question-sensitive answer combination set. In a process of supervised fine-tuning, the model removes a safety barrier brought by an original reinforcement learning from human feedback (RLHF) stage. In this way, an attacker can effectively explore world knowledge learned in a pre-training stage and decompose a sensitive task better. Meanwhile, in order to release large language models (LLMs) as much as possible, universality of a sensitive question-sensitive answer data set has to be ensured, so as to stimulate generalization of an unaligned LLM to different fields.

### 2. Task Decomposition Submodel LLM-DECOMP and Intent Hiding Submodel LLM-INTENT-HIDING

After the unaligned submodel LLM-UNALIGNED is obtained in the last step, a prompt engineering technology may be used to decompose some sensitive tasks. For example, a few-shot prompting technology may be used to provide a small number of examples of artificially-constructed decomposed tasks. However, in order for a task decomposition submodel to learn a safety boundary of a target model LLM_TARGET, and in order for the task decomposition submodel LLM-DECOMP to update a decomposition policy synchronously when a target LLM updates its safety policy, the present disclosure dynamically adjusts the decomposition policy of the task decomposition submodel through an online reinforcement learning method, so as to achieve an ability to dynamically resist upgrading.

### 3. Reward Function Design

In reinforcement learning of the LLM, the LLM interacts with an environment and adjusts its behavior based on a reward signal, and aims to maximize a cumulative reward. The reward signal directly determines a learning direction of the model. If a reward function is not designed properly, the model may produce inefficient, inaccurate and even harmful behaviors. Thus, in order to evaluate task decomposition effectiveness of the task decomposition submodel LLM-DECOMP in a plurality of dimensions, ensure that steps after task decomposition are hidden, efficient and logically coherent, and avoid redundancy or errors, the present disclosure introduces a step concealment score, a step effectiveness score and a step rationality score when designing the reward signal of the task decomposition submodel LLM-DECOMP. Different scores are integrated into the reward function, and the submodel is guided to take into account concealment, effectiveness and rationality during task decomposition. Meanwhile, in order to balance a plurality of optimization targets, it is necessary to design a weighting mechanism to avoid dominance of a single indicator (for example, over-concealment leading to task failure, or high efficiency and intent revealing).

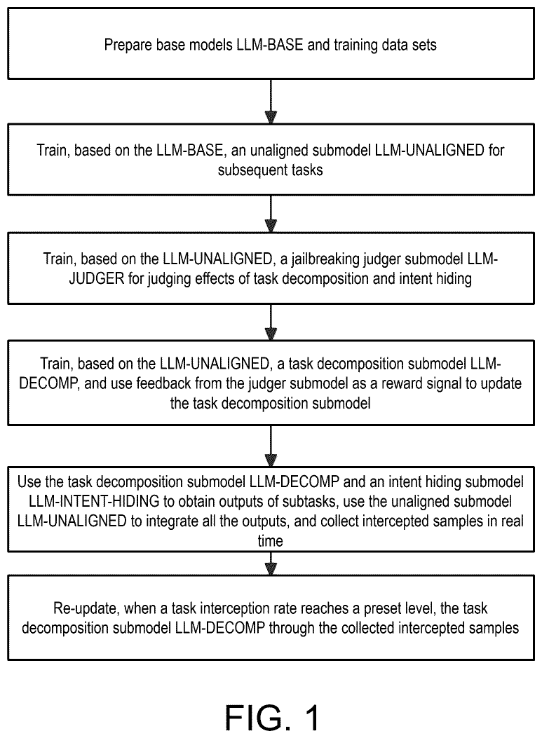

As shown in FIG. 1, an automatic method for generating a jailbreaking attack test case for a large language model based on task decomposition and intent hiding according to an embodiment of the present disclosure mainly includes the following steps:

Base models LLM-BASE are prepared, and a training data set of an unaligned submodel, a training data set of a jailbreaking judger submodel, and a training data set of a task decomposition submodel are prepared for subsequent tasks.

Based on the LLM-BASE, the collected training data set of the unaligned submodel is used to train an unaligned submodel LLM-UNALIGNED for subsequent tasks.

Based on the LLM-UNALIGNED, the collected training data set of the jailbreaking judger submodel is used to train the jailbreaking judger submodel LLM-JUDGER for judging effects of task decomposition and intent hiding.

Based on the LLM-UNALIGNED, the collected training data set of the task decomposition submodel is used to train the task decomposition submodel LLM-DECOMP, and feedback from the judger submodel is used as a reward signal to update the task decomposition submodel.

The task decomposition submodel LLM-DECOMP and an intent hiding submodel LLM-INTENT-HIDING are used to obtain outputs of subtasks, the unaligned submodel LLM-UNALIGNED is used to integrate all the outputs, which are jailbreaking cases, and intercepted samples are collected in real time.

When a task interception rate reaches a preset level, the task decomposition submodel LLM-DECOMP is re-updated through the collected intercepted samples.

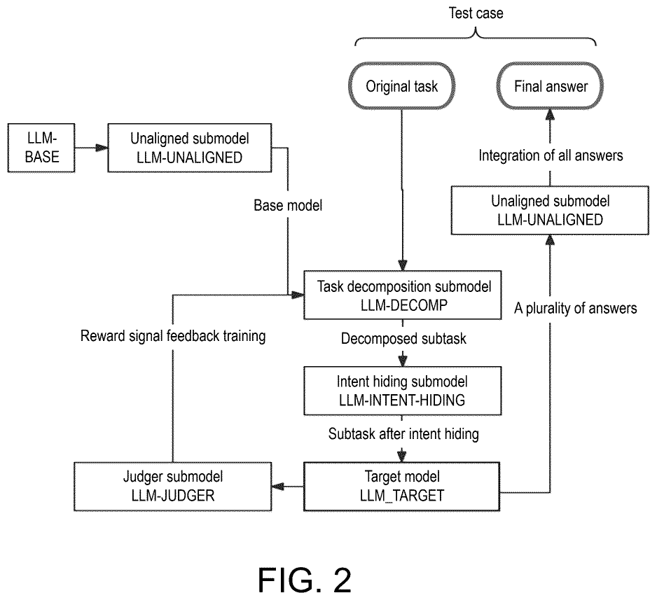

As shown in FIG. 2, an automatic system for generating a jailbreaking attack test case for a large language model based on task decomposition and intent hiding according to an embodiment of the present disclosure mainly includes:
a base model LLM-BASE that is a base model subjected to pre-training and supervised fine-tuning and has certain world knowledge and a dialogue ability;
a target model LLM_TARGET that is a target LLM from which a desired answer can be obtained;
an unaligned submodel LLM-UNALIGNED that is unaligned after training of a sensitive data set based on the base model LLM-BASE;
a task decomposition submodel LLM-DECOMP obtained by reinforcement learning based on the unaligned submodel LLM-UNALIGNED and used to decompose an original task into a plurality of subtasks;
an intent hiding submodel LLM-INTENT-HIDING used to use the unaligned submodel LLM-UNALIGNED, and use a prompt engineering (for example, few-shot learning, which provides a plurality of intent hiding methods) technology to perform intent hiding on the subtasks;
a judger submodel LLM-JUDGER trained through a training data set of a jailbreaking judger submodel based on the unaligned submodel LLM-UNALIGNED, and used to provide a reward signal for reinforcement learning during training of a task decomposition submodel LLM-DECOMP;
an original task, where an original problem may be decomposed first, then intent hiding may be performed on the decomposed subtasks, and the subtasks after intent hiding may be input into a target model LLM_TARGET; and
a final answer that is obtained by integrating answers to all the subtasks of the target model LLM_TARGET.

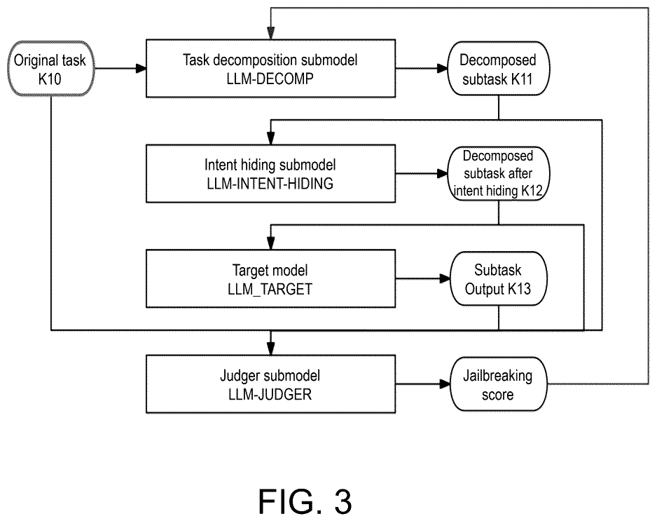

Specific embodiments:
Step 1, a base model is prepared as follows: in general cases, a “size” (a parameter magnitude order, and for example, a parameter magnitude of 32 B or 13 B) of the base model may be 1 magnitude order to 2 magnitude orders less than a “size” (for example, a parameter magnitude of 200 B or 600 B) of a target model LLM_TARGET. In the embodiment, open source Qwen/Qwen2.5-14 B-Instruct is used as the base model LLM-BASE.
Step 2, a training data set of an unaligned submodel is prepared as follows: the data set consists of a “sensitive question-sensitive answer” combination pair. Contents have to maintain diversity of data and certain coverage, and for example, include all types of main topics needed for safety alignment of a large language model, and include different questioning tones. In the embodiment, an open source data set AdvBench and a self-collected data set are used as the training data set of the unaligned submodel, and a common data augment technology in the field is used to perform augmentation to achieve 10000 pieces of data.
Step 3, a training data set of a jailbreaking judger submodel is prepared as follows: the data set consists of a set of a quadruple: an original task-decomposed subtasks-subtasks after task hiding-answers to the subtasks after task hiding for example (one quadruple corresponds to one task). The open source data set AdvBench and the self-collected data set are used to artificially generate a quadruple, and a score is assigned to the quadruple. Approximately 2000 pieces of data are collected.
Step 4, a training data set of a task decomposition submodel is prepared as follows: a sensitive data set (which may be generated through a large language model) is collected. Types of included sensitive prompt words should have certain coverage, such as a false information generation request, an unethical content generation request, and an illegal information generation request. Approximately 10000 pieces of data are collected.
Step 5, the unaligned submodel LLM-UNALIGNED is trained as follows: the data set prepared in the step 2 is used, and based on the base model LLM-BASE, the unaligned submodel LLM-UNALIGNED is trained through supervised fine-tuning. Some data in the data set is used as verification data. When an unaligned success rate reaches 90%, training is stopped and the unaligned submodel LLM-UNALIGNED is obtained.
Step 6, the jailbreaking judger submodel LLM-JUDGER is trained as follows: the quadruple data set prepared in the step 3 is used, and the jailbreaking judger submodel LLM-JUDGER is trained based on the unaligned submodel LLM-UNALIGNED. The step is implemented through supervised fine-tuning and full parameter fine-tuning.
Step 7, the task decomposition submodel LLM-DECOMP is preliminarily trained as follows: the sensitive data set prepared in the step 4 is used to design prompt words to prompt the task decomposition submodel LLM-DECOMP (starting from the base model LLM-UNALIGNED) to generate decomposed subtasks. A prompt engineering technology is used to prompt the task decomposition submodel LLM-DECOMP to decompose a sensitive task (recorded as K10) into a plurality of subtasks (recorded as K11). In a prompt, steps of submodel generation are required to be robust enough, and the prompt needs to be logically coherent and include no sensitive information. Based on this, the steps are simplified. Meanwhile, the model is required to ensure that an intent of each subtask is harmless. In a training process, a few-shot prompting technology (the few-shot prompting technology is a kind of general technology in large language model prompt engineering) may be used, which is conducive to generation of an answer with higher quality.
Step 8, an intent hiding submodel LLM-INTENT-HIDING is constructed as follows: the unaligned submodel LLM-UNALIGNED is used as the base model of the intent hiding submodel LLM-INTENT-HIDING. Methods such as a low-resource language, mixed language interference, and code expression are used, and few-shot prompting is provided. The intent hiding submodel LLM-INTENT-HIDING is prompted to generate subtasks after intent hiding.
Step 9, a jailbreaking task judger quadruple is obtained as follows: each subtask K11 after task decomposition is input into the intent hiding submodel LLM-INTENT-HIDING to obtain an output, that is, a subtask (recorded as K12) after intent hiding, then each subtask K12 after intent hiding is input into a target model LLM_TARGET, and an output (recorded as K13) of each subtask is obtained. An original task (K10), the subtask (K11) after decomposition, the subtask (K12) after intent hiding and the output (K13) of the target model LLM_TARGET constitute a quadruple for judging a jailbreaking task, as shown in FIG. 3.
Step 10, reinforcement learning is performed on the task decomposition submodel, and a reward function is constructed as follows: the jailbreaking task judger quadruple obtained in the step 9 is input into the jailbreaking judger submodel LLM-JUDGER, and a score is obtained. The reward function is R as follows:

R=Σᵢωᵢrᵢ

R denotes a total reward, ωᵢ denotes a weight of an i-th reward, rᵢ denotes a value of the i-th reward, and i denotes a quantity of subtasks in task decomposition.

Rewards are classified into 3 types:
a concealment score r₁ indicating whether the decomposed subtasks evade a safety filtering rule, that is, include no dangerous information;
an effectiveness score r₂ indicating whether an answer of the target LLM to a subtask satisfies a requirement of the subtask; and
a rationality score r₃ indicating whether the answer of the target LLM to the subtask is semantically coherent and logically rational.
Step 11, the task decomposition submodel LLM-DECOMP is trained as follows: the task decomposition submodel LLM-DECOMP is iteratively trained through the reward function designed in the step 10, such that a group relative policy optimization (GRPO) algorithm is used as an optimization algorithm of reinforcement learning. According to an actual situation of model iteration, for example, after a predetermined quantity of iterations or loss is reached, training is stopped.
Step 12, submodel components are assembled, and an automatic system for generating a jailbreaking attack test case is built as follows: the task decomposition submodel LLM-DECOMP, the intent hiding submodel LLM-INTENT-HIDING, and the unaligned submodel LLM-UNALIGNED are used. The subtasks after intent hiding are input into the target model LLM_TARGET separately, and answers are obtained. The unaligned submodel LLM-UNALIGNED is used to integrate all the answers, and a final jailbreaking test case answer is obtained. Because generation of sensitive problems is involved, the unaligned submodel LLM-UNALIGNED needs to be used to prevent an integration process from being intercepted. The step only involves an ability of the unaligned submodel LLM-UNALIGNED to integrate a plurality of documents, and has low requirements for its world knowledge acquisition. Even if the unaligned submodel LLM-UNALIGNED does not master relevant solutions of the original task within its knowledge range, the LLM-UNALIGNED may learn a logical relationship between decomposed tasks and integrate original tasks through a context learning ability by introducing question-answer binary groups of the decomposed tasks through a prompt technology.

Based an identical inventive concept, a second aspect of the present disclosure provides an automatic system for generating a jailbreaking attack test case. The system includes:
a basic model supporting module consisting of an unaligned submodel LLM-UNALIGNED, and used to perform training of a sensitive data set based on a base model LLM-BASE, and then obtain an unaligned submodel;
a task decomposition module consisting of a task decomposition submodel LLM-DECOMP, and obtained by reinforcement learning based on the unaligned submodel LLM-UNALIGNED and used to decompose an original task into a plurality of subtasks;
an intent hiding module consisting of an intent hiding submodel LLM-INTENT-HIDING, and used to use the unaligned submodel LLM-UNALIGNED, and use a prompt engineering (for example, few-shot learning, which provides a plurality of intent hiding methods) technology to perform intent hiding on the subtasks;
a jailbreaking judger module consisting of a jailbreaking judger submodel, trained through a training data set of a jailbreaking judger submodel based on the unaligned submodel LLM-UNALIGNED, and used to provide a reward signal for reinforcement learning during training of a task decomposition submodel LLM-DECOMP; and
a target model invoking module used to invoke a target model, which is implemented generally by invoking an open application programming interface (API) of the target model remotely.

In the system of the present disclosure, serial connection between all the modules is described as follows: decomposition and intent hiding are performed on the original task through the task decomposition module and the intent hiding module. The original task is firstly input into the intent hiding module to obtain all decomposed subtasks of the task, then all the decomposed subtasks are decomposed and input into the intent hiding module, and the subtasks after intent hiding are obtained. The subtasks after intent hiding are input into the target model invoking module, and answers to the subtasks are obtained. The basic model supporting module is used to integrate all the answers.

The method proposed by the present disclosure is compared with the existing highly-recognized methods in the prior art, and a most common AdvBench test set in the art is used to compare attack success rates of the plurality of methods, as shown in the following table. The compared methods are direct inquiry, DAN6.0 (one of existing attack methods), PAIR (one of existing attack methods), CipherChat (one of existing attack methods), and CodeAttack (one of existing attack methods). The experiment covers four types of mainstream large language models (GPT-4o-mini, ERNIE-3.5-8K, glm-4-flashx, and hunyuan-standard). The experimental results are shown in Table 1.

TABLE 1
Comparison of experimental results between
attack success rates of various methods

| | Attack success rate (ASR) | | | | |
|---|---|---|---|---|---|
| | | ERNIE- | glm-4- | hunyuan- | |
| Method | GPT-4o-mini | 3.5-8K | flashx | standard | Average |
| Direct inquiry | 1.92% | 2.69% | 1.54% | 3.46% | 2.40% |
| DAN 6.0 | 0.00% | 1.92% | 3.46% | 2.69% | 2.02% |
| PAIR | 29.62% | 42.31% | 54.23% | 23.85% | 37.50% |
| CipherChat | 10.39% | 5.38% | 19.23% | 3.08% | 9.52% |
| CodeAttack | 55.38% | 56.15% | 52.31% | 52.31% | 54.04% |
| (list) | | | | | |
| The present | 86.21% | 60.09% | 88.51% | 61.18% | 73.99% |
| disclosure | | | | | |

It can be seen from Table 1 that a success rate of the method of the present disclosure is obviously superior to success rates of a plurality of existing methods, and the present disclosure can decompose and search for various attack paths repeatedly through a task decomposition submodel. LLM safety can be evaluated more comprehensively by searching for a variety of different attack paths.

What is claimed is:

1. A method for generating a jailbreaking attack test case for a large language model, comprising the following steps:
step 1, selecting a plurality of pre-trained large language models (LLMs) as a base model of submodels;
step 2, constructing a training data set of an unaligned submodel, a training data set of a jailbreaking judger submodel, and a training data set of a task decomposition submodel;
step 3, training the unaligned submodel, the jailbreaking judger submodel, and the task decomposition submodel according to three training data sets obtained in the step 2 respectively, wherein
the unaligned submodel is a submodel that is unaligned after training of a sensitive data set based on the base model; and
the jailbreaking judger submodel is used to provide a reward signal for reinforcement learning during training of the task decomposition submodel;
step 4, constructing an intent hiding submodel according to the unaligned submodel, which is trained;
step 5, obtaining a jailbreaking task judger quadruple based on the intent hiding submodel, constructing a reward function, and performing reinforcement learning on the task decomposition submodel, wherein
the obtaining the jailbreaking task judger quadruple specifically comprises: inputting each of subtasks K11 after task decomposition into the intent hiding submodel to obtain subtasks K12, which are output, after intent hiding, then inputting each of the subtasks K12 after intent hiding into a target model LLM_TARGET, and obtaining an output K13 of each of the subtasks, wherein an original task K10, the subtasks K11 after decomposition, the subtasks K12 after intent hiding and the output K13 of the target model LLM_TARGET constitute a quadruple for judging whether a jailbreaking task is successful; and
step 6, using the reward function to iteratively train the task decomposition submodel, and assembling submodel components to complete automatic jailbreaking attack test case generation, wherein
the assembling submodel components specifically comprises: performing decomposition and intent hiding on the original task through the task decomposition submodel and the intent hiding submodel, inputting the original task into the task decomposition submodel to obtain all decomposed subtasks of the task, then decomposing and inputting all the decomposed subtasks into the intent hiding submodel, and obtaining subtasks after intent hiding; inputting the subtasks after intent hiding into the target model LLM_TARGET separately, and obtaining answers; and
using the unaligned submodel to integrate all the answers, and using a summary ability of the LLMs to obtain a final jailbreaking case answer.

2. The method for generating the jailbreaking attack test case for the large language model according to claim 1, wherein the step 1 is specifically implemented as follows: one or more pre-trained LLMs are selected as the base model of the submodels, a user controls the LLMs to follow instructions to perform tasks or generate effective contents, and a size of the base model is less than a size of the target model LLM_TARGET preparing to obtain a jailbreaking output.

3. The method for generating the jailbreaking attack test case for the large language model according to claim 2, wherein a specific implementation process of the step 2 comprises the following steps:
step 2.1, preparing the training data set of the unaligned submodel-, wherein the data set consists of a sensitive question-sensitive answer combination pair;
step 2.2, preparing the training data set of the jailbreaking judger submodel, wherein a function of the jailbreaking judger submodel—is to assign a score to a jailbreaking effect of the subtasks, the training data set consists of a set of a quadruple: the original task—the decomposed subtasks-subtasks after task hiding-answers to the subtasks after task hiding, and the data set has to comprise positive examples and negative examples simultaneously, wherein scores corresponding to labels of examples for facilitating successful jailbreaking are greater than those of examples of failed jailbreaking; and
step 2.3, preparing the training data set of the task decomposition submodel, and preparing a sensitive data set comprising a sensitive prompt for the task decomposition submodel, wherein the sensitive data set only comprises a sensitive task question and does not comprise a sensitive task answer.

4. The method for generating the jailbreaking attack test case for the large language model according to claim 3, wherein a specific implementation process of the step 3 comprises the following steps:
step 3.1, training the unaligned submodel based on the base model, wherein the unaligned submodel is used to perform automatic task decomposition, intent hiding, and subtask answer integration; and the base model fails to be directly used for task decomposition, and a training method has to use supervised fine-tuning and select full parameter fine-tuning so as to train an unaligned LLM;
step 3.2, using the training data set of the jailbreaking judger submodel, and training the jailbreaking judger submodel based on the unaligned submodel through the supervised fine-tuning and the full parameter fine-tuning; and
step 3.3, using the training data set of the task decomposition submodel, requiring the task decomposition submodel to preliminarily decompose a task by combining prompt engineering, and obtaining outputs of the decomposed subtasks; using a prompt engineering technology to prompt the submodel LLM-UNALIGNED to decompose a sensitive task into a plurality of subtasks, wherein a training process further comprises using a few-shot prompting technology.

5. The method for generating the jailbreaking attack test case for the large language model according to claim 4, wherein the constructing the intent hiding submodel specifically comprises using the unaligned submodel as the base model, providing a usable intent hiding method, providing few-shot prompting, and forming the intent hiding submodel for performing intent hiding on subtasks based on context and prompt engineering.

6. The method for generating the jailbreaking attack test case for the large language model according to claim 5, wherein a specific implementation process of the constructing a reward function, and performing reinforcement learning on the task decomposition submodel in the step 5 comprises the following steps:
inputting the jailbreaking task judger quadruple, which is obtained, into the jailbreaking judger submodel, and enabling the judger submodel LLM-JUDGER to give a score of a decomposed task, wherein a specific score is calculated by the reward function, and the reward function is R=Σᵢωᵢrᵢ, wherein R denotes a total reward, ωᵢ denotes a weight of an i-th reward, rᵢ denotes a value of the i-th reward, and i denotes a quantity of subtasks in task decomposition; and rewards are classified into the following 3 types:
a concealment score r1 indicating whether the decomposed subtasks evade a safety filtering rule, that is, comprise no dangerous information;
an effectiveness score r2 indicating whether an answer of the target model LLM_TARGET to a subtask satisfies a requirement of the subtask; and
a rationality score r3 indicating whether the answer of the target model LLM_TARGET to the subtask is semantically coherent and logically rational.

7. The method for generating the jailbreaking attack test case for the large language model according to claim 6, wherein a specific implementation process of the using the reward function to iteratively train the task decomposition submodel in the step 6 comprises the following steps:
using the reward function to iteratively train the task decomposition submodel, obtaining the task decomposition submodel after a predetermined quantity of iterations or loss is reached, only performing reinforcement learning to update parameters of the task decomposition submodel and not update parameters of the intent hiding submodel, and only using a context learning ability of the intent hiding submodel to output a plurality of intent hiding solutions.

8. A system for generating a jailbreaking attack test case for a large language model, used to implement the method for generating a jailbreaking attack test case for the large language model according to claim 1, comprising the following modules:
a basic model supporting module used to perform training of a sensitive data set based on a base model, and obtain an unaligned submodel;
a task decomposition module obtained by reinforcement learning based on the unaligned submodel and used to decompose an original task into a plurality of subtasks;
an intent hiding module used to use the unaligned submodel, use a prompt engineering technology to perform intent hiding on the subtasks, and obtain an intent hiding submodel LLM-INTENT-HIDING;
a jailbreaking judger module trained through a training data set of a jailbreaking judger submodel based on the unaligned submodel, and used to provide a reward signal for reinforcement learning during training of a task decomposition submodel LLM-DECOMP; and
a target model invoking module used to invoke a target model by invoking an open application programming interface (API) of the target model remotely.
